(19) United States
(12) Patent Application Publication
(10) Pub. No.: US 2002/0195292 A1
(43) Pub. Date: Dec. 26, 2002

(54) Power steering gearbox mechanism for a vehicle including a hydraulic fluid flow control device dependant from a speed at which the vehicle is running

(75) Inventor: Adrian Ballester, Buenos Aires (AR)

Correspondence Address: John S. Egbert, Harrison & Egbert, 7th Floor, 412 Main Street, Houston, TX, 77002, US

(73) Assignee: VISTEON AUTOMOTIVE SYSTEMS, INC., Dearborn, MI

(21) Appl. No.: 10/171,392

(22) Filed: Jun. 13, 2002

(30) Foreign Application Priority Data
Jun. 21, 2001 (AR) 01 01 02962

(51) Int. Cl. B62D 5/00

(52) U.S. Cl. 180/404; 180/422; 180/446

(57) ABSTRACT

A steering gearbox mechanism for automotive vehicles which allows the connection and disconnection of the steering gearbox assistance mechanism (hydraulic, electric or the like), depending on the vehicle working conditions. Thus, when the vehicle is stopped or circulating at a very low speed, the assistance mechanism assists the steering mechanism allowing the user to carry out the maneuver effortlessly, and when the vehicle circulates at a higher speed, the assistance is disconnected, and the vehicle's engine does not impel the pump since the user can carry out any maneuver without any effort. Summing up, the present invention is referred to a power steering gearbox mechanism for vehicles, comprising an assisted rack bar-and-pinion steering mechanism characterized by comprising a control means that detects the vehicle's working condition, and at a certain speed is capable of sending a signal for disconnecting the steering assistance.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention is referred to a hydraulically powered steering gearbox mechanism for vehicles, which is capable of controlling such assistance relying on the speed of the vehicle. More particularly, it is referred to a steering gearbox mechanism that includes control means of said power steering for activating and disabling the same based on the information coming from other measurement means of the vehicle, such as the on-board computer. Basically, the present invention is referred to a system for controlling the assistance of the powered steering mechanism depending on the speed at which the vehicle is running, and based on this information the power assistance may be connected or disconnected.

### BACKGROUND OF THE INVENTION

At present, there are in the market thousands of different kinds of power steering gearboxes. Most of them, and those most broadly applied by the automotive industry, are hydraulic power steering gearboxes which include an assistance pump that energizes a hydraulic circuit that is the one in charge of assisting the rack bar and pinion gear mechanism of the steering gearbox.

This kind of assistance presents the inconvenience that it is permanently connected while the vehicle is running, either when circulating at 20 km/h or 150 km/h. It is already known in the automotive industry that the steering gearboxes require such assistance only when the vehicle requires maneuvering at low speed, while at high speed power steering mechanisms are practically unnecessary, however the assistance pump continues working, consuming unnecessary energy which may range between 4-5 HP.

It is in fact an object of the present invention a device which allows to disconnect the assistance pump when the vehicle circulates under certain parameters, for example at high speed. This would allow the pump to disconnect and avoiding the engine of continuing impelling a pump unnecessarily, with the resulting engine wear and fuel consumption.

There are several mechanisms to control the assistance depending on the engine working conditions. For example, the U.S. Pat. No 5,740,880 of Miller et al., discloses an electric steering gearbox that includes a system by which the applied power to the attendance adjusts to the rotor stream according to the engine speed. While the vehicle circulates at low speed, for example in parking maneuvers, where engine speed is almost zero, rotor stream is maximum, while when circulating at high speed, for example when it moves along by a highway or by a route, the rotor stream is minimum so as to minimize energy losses generated by the internal mechanisms. This solution can be applied to an electric steering gearbox, but cannot be applied to a hydraulic gearbox, since it wouldn't be possible to regulate pump pressure, like the value of the current in the mentioned case.

It's important to mention that U.S. Pat. No. 5,794,736 refers to a fluid control system for a hydraulic steering gearbox that includes a control system that comprises a first valve that regulates fluid flow in response to the required torque to manually drive the steering gearbox. Said first valve in turn includes two independent measurement valves to measure the fluid flow and at least one of them communicates with a drain through a second valve which connects and disconnects one of said independent valves in response to the vehicle speed.

All of these mechanisms tends to regulate the fluid pressure by acting on the fluid pump or regulating the flow through valves, in order to maximize circuit power when the vehicle is stopped or running at very low speed and to minimize it at high speed.

None of the well-known means disconnects the assistance means completely depending on the vehicle working conditions, as the present invention.

### BRIEF SUMMARY OF THE INVENTION

It is an object of the present invention for a steering gearbox mechanism for automotive vehicles which allows the connection and disconnection of the steering gearbox assistance mechanism (hydraulic, electric or the like), depending on the vehicle working conditions. Thus, when the vehicle is stopped or circulating at a very low speed, the assistance mechanism assists the steering mechanism allowing the user to carry out the maneuver effortlessly, and when the vehicle circulates at a higher speed, the assistance is disconnected, and the vehicle's engine does not impel the pump since the user can carry out any maneuver without any effort.

Summing up, the present invention is referred to a power steering gearbox mechanism for vehicles, comprising an assisted rack bar-and-pinion steering mechanism characterized by comprising a control means that detects the vehicle's working condition, and at a certain speed is capable of sending a signal for disconnecting the steering assistance.

### BRIEF DESCRIPTION OF THE SEVERAL VIEWS OF THE DRAWINGS

The above mentioned features are some of the most important improvements of the present invention, which will be described in detail in accordance with the accompanying drawings, as an illustrative example thereof, in which:

FIG. 1 schematically shows the proposed gearbox, with the assistance pump, the electronic control means, and the connection-disconnection proposed means.

FIG. 2 shows in detail the magnetic pulley used to carry out said connection and disconnection of the assistance means.

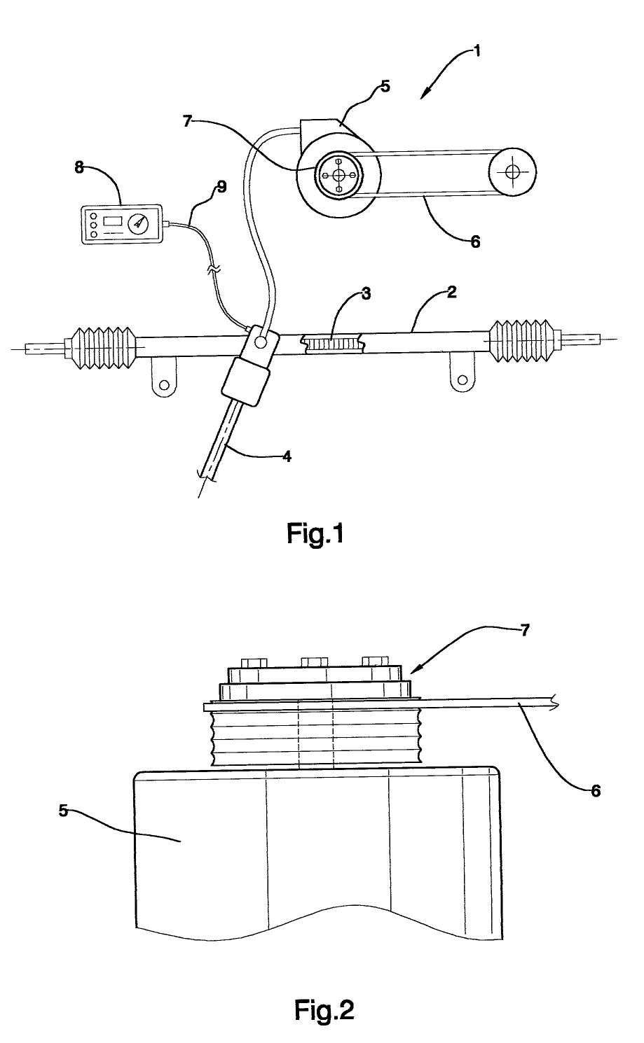

### DETAILED DESCRIPTION OF THE INVENTION

Making reference to the accompanying drawings, the present invention, indicated with the general reference 1, comprises a steering gearbox 2 that, as usual, comprises a rack bar 3 connected through a pinion to the driving column 4 of the vehicle. Said assistance means comprises a pump 5 impelled by the vehicle's engine through a belt 6 and it is connected to the steering mechanism 2 channeling the hydraulic pressurized fluid to assist said mechanism. Said pump 5 comprises a pulley 7 that, in the illustrated case, it is a magnetic pulley which, as it is already known in the art, is able to be connected or to be disconnected by an electric signal received from some control means. In this case said control means can be the vehicle on-board computer which, schematically indicated with reference 8, sends information through a connector 9. Said computer can be programmed so that, when the vehicle is running at a certain speed, an electric signal to said magnetic pulley 7 is sent for disconnecting said pump 5 from the vehicle engine.

Thus, when the vehicle circulates at certain working conditions, for example between 0 to 60 km/h, the pump is connected permanently, offering constant assistance to the gearbox, while when the vehicle circulates at more than 60km/h, a signal is sent by the computer for disconnecting the magnetic pulley 7 and therefore the engine stops impelling the pump 5. Thus, the vehicle saves fuel, since the pump usually consumes between 4 and 5 CV from the vehicle's engine available power. At the same time, a longer duration of the assistance pump is achieved that only works when the vehicle working conditions so requires.

Although a realization has been illustrated in which a hydraulic assistance means is involved, this is not limitative that in practice any type of power steering gearbox can be used. Avoiding the pump assistance when the vehicle does not require it is a beneficial aim for the vehicle in any assistance system used.

By means of a conceptual and structurally simple invention, improve the traditional power steering gearbox is possible, simultaneously achieving fuel saving and less engine wasting.

I claim:

1. A power steering gearbox mechanism for vehicles, comprising
an assisted rack bar-and-pinion steering mechanism characterized by comprising a control means that detects the vehicle's working condition, and at a certain speed is capable of sending a signal for disconnecting the steering assistance.

2. A power steering gearbox, according to claim 1, characterized because said assistance comprises a hydraulic pump for feeding a hydraulic circuit which assists the steering gearbox, said pump includes a magnetic pulley connected to the vehicle's engine capable of disconnecting said pump when a signal coming from said control means is received.

3. A power steering gearbox, according to claim 1, characterized because said control means is the vehicle on-board computer.

4. A power steering gearbox, according to claim 1, characterized by said control means sends a disconnection signal to the assistance means when the vehicle circulates at a speed higher than 60 km/h.
